(19) United States
(12) Patent Application Publication
(10) Pub. No.: US 2016/0104405 A1
(43) Pub. Date: Apr. 14, 2016

(54) DRIVE CIRCUIT AND DISPLAY DEVICE

(71) Applicant: Shenzhen China Star Optoelectronics Technology Co. Ltd., Shenzhen, Guangdong (CN)

(72) Inventors: Zhaolin Fang, Guangdong (CN); Dongsheng Guo, Guangdong (CN); Yu-Yeh Chen, Guangdong (CN); Feng Cheng Xu, Guangdong (CN)

(21) Appl. No.: 14/410,924

(22) PCT Filed: Oct. 21, 2014
(86) PCT No.: PCT/CN2014/089117

§ 371 Date: Dec. 23, 2014

(30) Foreign Application Priority Data
Oct. 13, 2014 (CN) 201410537605.4

(51) Int. Cl. G09G 3/20

(52) U.S. Cl. CPC G09G 3/20; G09G 2320/045; G09G 2320/0673; G09G 2310/08

(57) ABSTRACT

A drive circuit and a display device are provided. The drive circuit comprises a programmable gamma IC, a timing controller, a memory, and a control interface. A display device is also provided. After starting up the drive circuit and the display device provided, the gamma value of the programmable gamma IC can be updated in real-time to make the output voltage controlled thereby as accurate as possible. Accordingly, the assembled display device can show the original object or source image more truly.

### BACKGROUND OF THE INVENTION

1. Field of the Invention

The present invention generally relates to a display field, and more particularly to a drive circuit and a display device.

2. Description of Prior Art

More and more people are using display devices for information acquisition and home entertainment. For guaranteeing the display quality of the display device, a corresponding drive circuit is generally set for performing the image quality control for the display device (such as the gamma value of the display device). The drive circuit can be arranged on the printed circuit board.

FIG. 1 depicts a structural diagram of a drive circuit in a display device according to prior art. The drive circuit 10 comprises a programmable gamma IC (P-gamma IC) 11, a timing controller (T-CON) 22, a memory 23, and a control interface 24. A NVM (Non-Volatile Memory) is set in the P-gamma IC for storing the gamma code provided to the P-gamma IC. As the drive circuit functions, an external signal may rewrite the gamma code in the NVM which leads to inconsistency of the gamma code in the P-gamma IC and the normal gamma code. Accordingly, it results in drifting of the gamma value outputted by the P-gamma IC.

Therefore, there is a need to design a drive circuit and a display device capable of preventing the drift of the gamma value outputted by the P-gamma IC for solving the aforesaid technical issues.

### SUMMARY OF THE INVENTION

In view of this, the present invention provides a drive circuit and a display device capable of outputting a steady gamma value to solve the technical issue that the gamma value outputted by the drive circuit and the display device drifts easily.

For solving the aforesaid technical issue, the embodiment of the present invention provides the following technical solution:

a drive circuit employed in a display device corresponding thereto, comprising:
a programmable gamma IC, providing a gamma value for adjusting image quality of the display device;
a timing controller, controlling working timing of the programmable gamma IC;
a memory, storing timing code of controlling the timing controller and gamma code of controlling the programmable gamma IC, wherein the gamma code is set in a blank section of the timing code; and
a control interface, receiving an external control signal;
wherein the programmable gamma IC is connected to the timing controller via a first connection line, and the timing controller is connected to the memory via a second connection line, and the timing controller is connected to the control interface via the second connection line, and the first connection line comprises a data output line and a clock output line; the second connection line comprises a data input line and a clock input line.

In the drive circuit of the present invention, the timing controller controls the memory to provide the gamma code to the programmable gamma IC for making the programmable gamma IC provide a steady gamma value.

In the drive circuit of the present invention, the timing controller controls the memory to periodically provide the gamma code to the programmable gamma IC.

In the drive circuit of the present invention, the timing controller acquires the timing code from the memory according to the external control signal to generate a timing signal for controlling the working timing of the programmable gamma IC.

In the drive circuit of the present invention, an external device controls the timing controller via the control interface and the second connection line.

In the drive circuit of the present invention, the gamma code is periodically and repeatedly set in the blank section of the timing code.

In the drive circuit of the present invention, the memory is an Electrically Erasable Programmable Read-Only Memory.

For solving the aforesaid technical issue, the embodiment of the present invention further provides the following technical solution:

a drive circuit employed in a display device corresponding thereto, comprising:
a programmable gamma IC, providing a gamma value for adjusting image quality of the display device;
a timing controller, controlling working timing of the programmable gamma IC;
a memory, storing timing code of controlling the timing controller and gamma code of controlling the programmable gamma IC; and
a control interface, receiving an external control signal;
wherein the programmable gamma IC is connected to the timing controller via a first connection line, and the timing controller is connected to the memory via a second connection line, and the timing controller is connected to the control interface via the second connection line.

In the drive circuit of the present invention, the timing controller controls the memory to provide the gamma code to the programmable gamma IC for making the programmable gamma IC provide a steady gamma value.

In the drive circuit of the present invention, the timing controller controls the memory to periodically provide the gamma code to the programmable gamma IC.

In the drive circuit of the present invention, the timing controller acquires the timing code from the memory according to the external control signal to generate a timing signal for controlling the working timing of the programmable gamma IC.

In the drive circuit of the present invention, an external device controls the timing controller via the control interface and the second connection line.

In the drive circuit of the present invention, the gamma code is set in a blank section of the timing code.

In the drive circuit of the present invention, the gamma code is periodically and repeatedly set in a blank section of the timing code.

In the drive circuit of the present invention, the memory is an Electrically Erasable Programmable Read-Only Memory.

In the drive circuit of the present invention, the first connection line comprises a data output line and a clock output line; the second connection line comprises a data input line and a clock input line.

The present invention further provides a display device employing the aforesaid drive circuit.

Compared with prior arts, the drive circuit and the display device of the present invention store the gamma code in the memory employed for storing the timing code, and periodically send the gamma code to the programmable gamma IC to allow the programmable gamma IC steadily output the gamma value; the technical issue that the gamma value outputted by the drive circuit and the display device drifts easily can be solved.

### BRIEF DESCRIPTION OF THE DRAWINGS

In order to give a better and more thorough understanding to the whole and other intended purposes, features, and advantages of the technical solution of the present invention, a detailed description will be given with respect to preferred embodiments provided and illustrated herebelow in accompanied drawings. It should be noted that within the spirit of the disclosed embodiments, a person in the skilled in the art can readily come up with other modifications as well as improvements without undue experiment. In addition, other drawings can be readily achieved based on the disclosed drawings.

FIG. 1 depicts a structural diagram of a drive circuit in a display device according to prior art.

FIG. 2 depicts a structural diagram of a drive circuit according to the preferred embodiment of the present invention.

FIG. 3 shows a diagram of working signals of the drive circuit according to the preferred embodiment of the present invention.

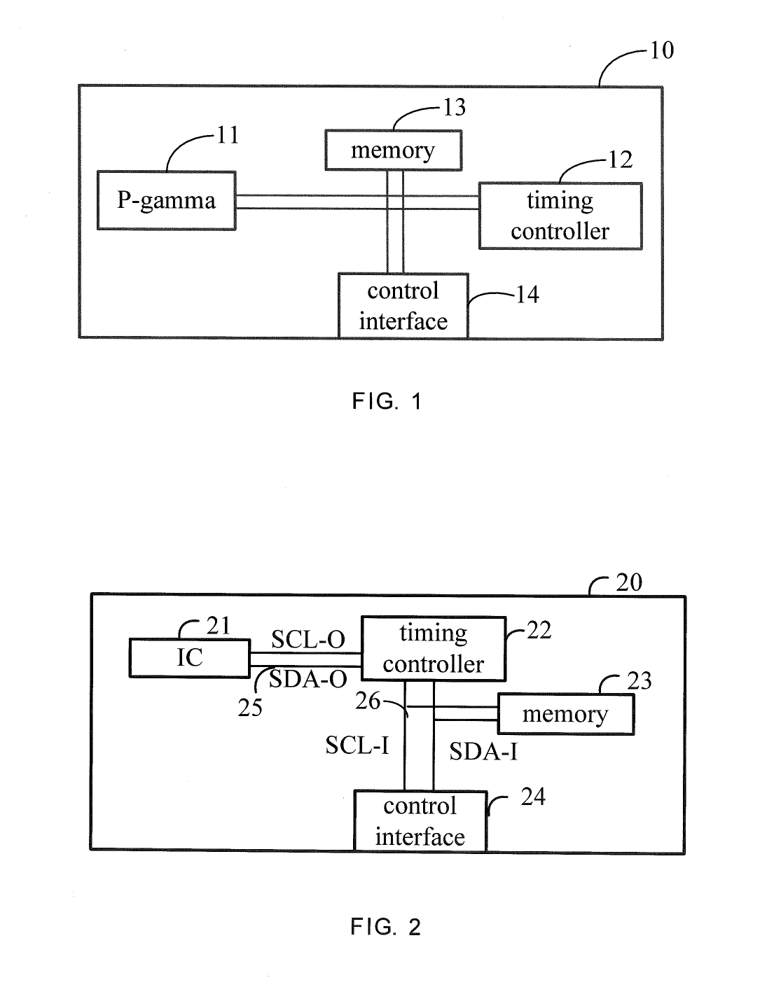

### DETAILED DESCRIPTION OF THE INVENTION

Please refer to figures in the appendix. The same element numbers in the figures represent the same element. The following description should be considered as merely disclosing the embodiments of the present invention, but not restricting of other embodiments of the present invention which are not revealed.

Please refer to FIG. 2., which is a structural diagram of a drive circuit according to the preferred embodiment of the present invention. The drive circuit 20 of the preferable embodiment comprises a programmable gamma IC 21, a timing controller 22, a memory 23, and a control interface 24. The programmable gamma IC 21 provides a gamma value for adjusting the image quality of the display device; the timing controller 22 controls working timing of the programmable gamma IC 21; the memory 23 stores timing code of controlling the timing controller 22 and gamma code of controlling the programmable gamma IC 21; the control interface 24 receives an external control signal.

The programmable gamma IC 21 is connected to the timing controller 22 via a first connection line 25, and the timing controller 22 is connected to the memory 23 via a second connection line 26, and meanwhile, the timing controller 22 is connected to the control interface 24 via the second connection line 26. An external device controls the timing controller 22 via the control interface 24 and the second connection line 26. The memory 23 is an Electrically Erasable Programmable Read-Only Memory. The first connection line 25 comprises a data output line SDA-O and a clock output line SCL-O. The second connection line 26 comprises a data input line SDA-I and a clock input line SCL-I.

As the drive circuit 20 of the present invention is in use, the timing code of controlling the timing controller 22 and gamma code of controlling the programmable gamma IC 21 are first stored in the memory 23. The gamma code can be periodically and repeatedly set in the blank section of the timing code because the timing code of the timing controller 22 has fewer active sections. That is, the gamma code is integrated into the timing code.

After the external device sends the external control signal to the timing controller 22 via the data input line SDA-I and the clock input line SCL-I, the timing controller 22 fetches the integrated timing code (i.e. the original timing code and the gamma code) from the memory 23 to generate a timing signal for controlling the working timing of the programmable gamma IC 21 and sends the gamma code in the aforesaid integrated timing code to the programmable gamma IC 21 via the data output line SDA-O and the clock output line SCL-O.

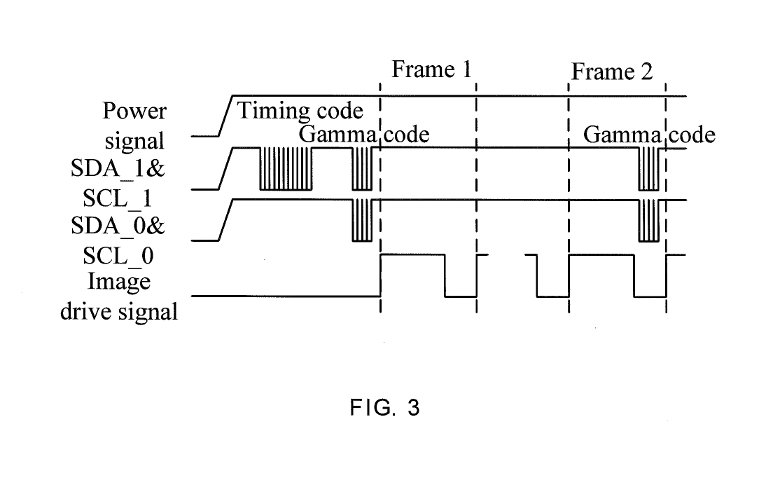

FIG. 3 is a diagram of working signals of the drive circuit according to the preferred embodiment of the present invention. The signal in the first row is a power signal. The signal in the second row is an integrated timing signal. The signal in the third row is a gamma signal. The signal in the fourth row is an image drive signal of the display device. As shown in FIG. 3, the timing controller 22 controls the memory 23 to periodically provide the gamma code to the programmable gamma IC 21 for updating the gamma code in the programmable gamma IC 21 for every interval of N frame signals (or every predetermined interval) to prevent the gamma code from being rewritten by the external signal. Even if the gamma code is rewritten by the external signal, the gamma code can still be updated back to the default setting value in the memory 23.

Preferably, the method of setting the predetermined interval comprises time division, Frame Rate control, Sub-Fields, Pulse Width Modulation, et cetera.

Preferably, the second connection line 26 comprises the data input line (SDA-I) and the clock input line (SCL-I) at the same time and arranged in pairs. Preferably, the first connection line 25 comprises the data output line (SDA-O) and the clock output line (SCL-O) at the same time and arranged in pairs.

Consequently, after starting up the drive circuit 20 of the display device according to the preferred embodiment of the present invention, the gamma code can be updated in real-time to make the output voltage controlled by the drive circuit 20 of the display device as accurate as possible. Occasional errors which appear due to noise interference will be corrected quickly. Accordingly, the assembled display device can show the original object or source image more truly.

The drive circuit according to the preferred embodiment of the present invention stores the gamma code in the memory employed for storing the timing code, and periodically sends the gamma code to the programmable gamma IC to allow the programmable gamma IC to steadily output the gamma value.

The present invention further provides a display device. The display device utilizes the aforesaid drive circuit to implement image driving. The specific working principle is the same as or similar to those of the aforesaid drive circuit in the preferred embodiment. Please refer to the related description of the aforesaid drive circuit in the preferred embodiment.

The drive circuit and the display device of the present invention store the gamma code in the memory employed for storing the timing code, and periodically send the gamma code to the programmable gamma IC to allow the programmable gamma IC to steadily output the gamma value; the technical issue that the gamma value outputted by the drive circuit and the display device drifts easily can be solved.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structures.

What is claimed is:

1. A drive circuit employed in a display device corresponding thereto, comprising:
a programmable gamma IC, providing a gamma value for adjusting image quality of the display device;
a timing controller, controlling working timing of the programmable gamma IC;
a memory, storing timing code of controlling the timing controller and gamma code of controlling the programmable gamma IC, wherein the gamma code is set in a blank section of the timing code; and
a control interface, receiving an external control signal;
wherein the programmable gamma IC is connected to the timing controller via a first connection line, and the timing controller is connected to the memory via a second connection line, and the timing controller is connected to the control interface via the second connection line, and the first connection line comprises a data output line and a clock output line; the second connection line comprises a data input line and a clock input line.

2. The drive circuit according to claim 1, wherein the timing controller controls the memory to provide the gamma code to the programmable gamma IC for making the programmable gamma IC provide a steady gamma value.

3. The drive circuit according to claim 2, wherein the timing controller controls the memory to periodically provide the gamma code to the programmable gamma IC.

4. The drive circuit according to claim 1, wherein the timing controller acquires the timing code from the memory according to the external control signal to generate a timing signal for controlling the working timing of the programmable gamma IC.

5. The drive circuit according to claim 4, wherein an external device controls the timing controller via the control interface and the second connection line.

6. The drive circuit according to claim 1, wherein the gamma code is periodically and repeatedly set in the blank section of the timing code.

7. The drive circuit according to claim 1, wherein the memory is an Electrically Erasable Programmable Read-Only Memory.

8. A drive circuit employed in a display device corresponding thereto, comprising:
a programmable gamma IC, providing a gamma value for adjusting image quality of the display device;
a timing controller, controlling working timing of the programmable gamma IC;
a memory, storing timing code of controlling the timing controller and gamma code of controlling the programmable gamma IC; and
a control interface, receiving an external control signal;
wherein the programmable gamma IC is connected to the timing controller via a first connection line, and the timing controller is connected to the memory via a second connection line, and the timing controller is connected to the control interface via the second connection line.

9. The drive circuit according to claim 8, wherein the timing controller controls the memory to provide the gamma code to the programmable gamma IC for making the programmable gamma IC provide a steady gamma value.

10. The drive circuit according to claim 9, wherein the timing controller controls the memory to periodically provide the gamma code to the programmable gamma IC.

11. The drive circuit according to claim 8, wherein the timing controller acquires the timing code from the memory according to the external control signal to generate a timing signal for controlling the working timing of the programmable gamma IC.

12. The drive circuit according to claim 11, wherein an external device controls the timing controller via the control interface and the second connection line.

13. The drive circuit according to claim 8, wherein the gamma code is set in a blank section of the timing code.

14. The drive circuit according to claim 8, wherein the gamma code is periodically and repeatedly set in a blank section of the timing code.

15. The drive circuit according to claim 8, wherein the memory is an Electrically Erasable Programmable Read-Only Memory.

16. The drive circuit according to claim 8, wherein the first connection line comprises a data output line and a clock output line; the second connection line comprises a data input line and a clock input line.

17. A display device employing the drive circuit according to claim 8.
